(19) United States
(12) Patent Application Publication
(10) Pub. No.: US 2023/0152787 A1
(43) Pub. Date: May 18, 2023

(54) PERFORMANCE OPTIMIZATION OF COMPLEX INDUSTRIAL SYSTEMS AND PROCESSES

(71) Applicant: INTERNATIONAL BUSINESS MACHINES CORPORATION, Armonk, NY (US)

(72) Inventors: Amadou BA, Navan (IE); Fabio LORENZI, Tyrrelstown (IE); Joern PLOENNIGS, Dublin (IE)

(73) Assignee: INTERNATIONAL BUSINESS MACHINES CORPORATION, Armonk, NY (US)

(21) Appl. No.: 17/455,293

(22) Filed: Nov. 17, 2021

(51) Int. Cl. G05B 19/418; G06N 3/08

(52) U.S. Cl. CPC G05B 19/41865; G06N 3/08; G05B 2219/32204

(57) ABSTRACT

Embodiments are provided for providing increased performance of various industrial systems and processes in a computing system by a processor. Each of a plurality of dependencies of a plurality of entities in a knowledge graph are modeled as a graph neural network (“GNN”). A reference graph model is generated based on the modeling. One or more anomalies are monitored and detected for a plurality of process based on the reference graph model.

### BACKGROUND OF THE INVENTION

### Field of the Invention

The present invention relates in general to computing systems, and more particularly, to various embodiments for providing increased performance of various industrial systems and processes by a processor.

### Description of the Related Art

In today's society, consumers, businesspersons, educators, and others communicate over a wide variety of mediums in real time, across great distances, and many times without boundaries or borders. With the increased usage of computing networks, such as the Internet, humans are currently inundated and overwhelmed with the amount of information available to them from various structured and unstructured sources. Due to the recent advancement of information technology and the growing popularity of the Internet, a wide variety of computer systems have been used in machine learning. Machine learning is a form of artificial intelligence (“AI”) that is employed to allow computers to evolve behaviors based on empirical data.

### SUMMARY OF THE INVENTION

According to an embodiment of the present invention, a method for providing increased performance of various industrial systems and processes in a computing environment, by one or more processors, is depicted. Each of a plurality of dependencies of a plurality of entities in a knowledge graph are modeled as a graph neural network (“GNN”). A reference graph model is generated based on the modeling. One or more anomalies are monitored and detected for a plurality of process based on the reference graph model.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a diagram depicting knowledge graph and a graph neural network in according to an embodiment of the present invention.

FIG. 5 is an additional block diagram depicting an exemplary functional relationship between various aspects of the present invention.

FIG. 6 in an additional block diagram of a knowledge graph and a graph neural network in a computing environment according to an embodiment of the present invention.

FIG. 7 is block diagram depicting operations for providing increased performance of various industrial systems and processes in a computing environment according to an embodiment of the present invention.

FIG. 8 is block diagram depicting operations for monitoring various industrial systems and processes in a computing environment according to an embodiment of the present invention.

FIG. 9 is a flowchart diagram depicting an additional exemplary method for providing increased performance of various industrial systems and processes in a computing environment according to an embodiment of the present invention.

FIG. 10 is a flowchart diagram depicting an additional exemplary method for monitoring various industrial systems and processes in a computing environment according to an embodiment of the present invention.

FIG. 11 is a flowchart diagram depicting an additional exemplary method for providing increased performance of various industrial systems and processes in a computing environment according to an embodiment of the present invention.

### DETAILED DESCRIPTION OF THE DRAWINGS

The present invention relates generally to knowledge graph databases in a computing environment. In knowledge graph databases, stored information is represented by means of a knowledge graph which has nodes interconnected by edges. Nodes of the graph represent entities for which entity data, characterizing those entities, is stored in the database. Entities may, for example, correspond to people, companies, devices, etc. More generally, nodes may represent any entity (real or abstract) for which information needs to be stored. The entity data stored for a node may comprise one or more data items, often called “properties” or “property values”, describing particular features of an entity. Edges of the graph represent relationships between entities. An edge connecting two nodes of the graph represents some defined relationship which is applicable to the entities represented by those nodes. A graph may accommodate different relationships between entities, with each edge having a specified type, indicated by an edge name or “label”, signifying the particular relationship represented by that edge. Nodes may also have associated names, or labels, to indicate different types or categories of node corresponding to different entity-types represented in the graph.

Knowledge graphs provide highly efficient structures for representing large volumes of diverse information about interrelated entities. Querying a knowledge graph database involves formulating a query request defining the information needed from the database in such a way that relevant nodes, edges, and properties can be identified, and then following edges in the graph to identify and extract the required data from storage. Knowledge graphs can be conveniently represented using matrices in which non-zero entries signify edges and rows, and column indices correspond to node identities. The process of identifying and extracting data for a query request can be implemented by performing mathematical operations on such matrices.

However, large scale and interconnected systems/processes are complex and difficult to monitor and difficult to gain access to a specific part of the system/process. Traditional modeling approaches are limited when the structure of the systems/processes are highly interconnected and there is need to capture the information associated with the interrelation between the various entities of the systems/processes. Thus, a need exists to provide performance optimization and modeling of large scale and complex industrial systems/processes using knowledge graph and AI operations.

Accordingly, in some implementations, the present invention provides a solution for providing increased performance of various industrial systems and processes in a computing environment, by one or more processors, is depicted. Each of a plurality of dependencies of a plurality of entities in a knowledge graph are modeled as a graph neural network (“GNN”). A reference graph model is generated based on the modeling. One or more anomalies are monitored and detected for a plurality of process based on the reference graph model.

In some implementations, the present disclosure provides an intelligent system for encompassing a Graph Neural Network (“GNN”) using knowledge base/representation to represent complex systems/processes. A knowledge graph, having one or more vertices (e.g., entities) connected by edges (interrelation between entities), may be identified and/or received. Each of the dependencies between the entities in the knowledge graph may be modeled using the GNN and the taxonomy/classification of entities may be determined while also predicting the links in the knowledge graph.

Each of the entities in the graph and each associated label may be exploited (e.g., each of the entities and the labels of the graph can be used to build the model and the monitoring approach and perform performance optimization). The labels of entities may be predicted without ground-truth (e.g., the prediction can be conducted without necessarily having the labels defined a priori such as, for example, as used in clustering where clustering is executed without any ground-truth label). A reference graph may be generated and/or established as a basis, upon arrival of new data. The reference graph combines the data and the metadata with the model (e.g., a knowledge graph model) to perform large scale monitoring of various systems/processes and anomaly diagnosis.

In some implementations, the GNN (e.g., a neural network on a graph) is a representation learning of one or more graphs and provides for capturing specifics of a graph (e.g., entities and their interrelations). By using the GNN, classifications/taxonomies (entities classification), link predictions, and graph clustering may be determined and identified, all of which may be used for monitoring and anomaly diagnosis in these complex, interconnected industrial systems/processes. In some implementations, the GNN may allow improved contextual monitoring and explainable diagnosis by exploiting one or more fundamentals of knowledge graph in representation learning.

In some implementations, the GNN is a neural networks that operate on graphs by learning a state of knowledge graph embeddings. In one aspect, in the GNN each entity of a graph is defined by its features and its related entities (e.g., neighborhood). The GNNs follow a recursive neighborhood aggregation, where each entity aggregates feature vectors of its neighbors to compute its own new feature vector. The representation of an entire graph can then be obtained through pooling such as, for example, by summing the representation vectors of all entities in the graph. In this way, the advantages of GNN is the capacity to model each of the dependencies between entities in a knowledge graph and capture the contextual structure of the graph. An application, where the GNN has proven efficient, is contextual entity classification, which can be exploited as an anomaly diagnosis approach, or prediction/clustering of entities without ground-truth.

In some implementations, the objective of GNN is to learn a state embedding, which contains the information pertaining to the neighborhood for each entity. The state embedding is a vector of the entity and can be used to produce an output such as the entity label. The GNN expresses a dynamical system whose state space representation is given by a state of the entity and its associated observation. The state of the entity is a function of the features vector of the entity in question, the features of its edges, the state of the neighborhood and the features of the entities in the neighborhood. While the observation is a function of the state of the entity and the feature of the entity, the occurrence of abnormalities at a given part of the graph will alter the parameters of the state space representation. In some implementations, detecting the abnormal deviation of the parameters of the model may be provided.

In some implementations, an increased and improved machine learning/artificial intelligence operation is provided for real-time monitoring of large scale, interconnected and complex systems/processes. The machine learning/artificial intelligence operation may include a GNN that learns the characteristics of an entity and its interrelation and predict the labels and links. The exploitation of the learning ability of GNN is used to build a monitoring approach of large scale, interconnected complex systems/processes. The approach operates by learning first the neighborhood of a given entity and predicting the links, then comparing the predicted links and entity features to the actual links and entity features. Discrepancies between the predicted links/entities and the actual ones are potential indications of anomalies. Exploitation of the knowledge graph and the GNN to configure pipelines for monitoring, allows to specify the area of interest for monitoring.

It should be noted as described herein, the term “intelligent” (or “cognitive/cognition”) may be relating to, being, or involving conscious intellectual activity such as, for example, thinking, reasoning, or remembering, that may be performed using a machine learning. In an additional aspect, cognitive or “intelligent may be the mental process of knowing, including aspects such as awareness, perception, reasoning and judgment. A machine learning system may use artificial reasoning to interpret data from one or more data sources (e.g., sensor based devices or other computing systems) and learn topics, concepts, and/or processes that may be determined and/or derived by machine learning.

In an additional aspect, cognitive or “intelligent” may refer to a mental action or process of acquiring knowledge and understanding through thought, experience, and one or more senses using machine learning (which may include using sensor based devices or other computing systems that include audio or video devices). Cognitive/intelligent may also refer to identifying patterns of behavior, leading to a “learning” of one or more events, operations, or processes. Thus, the intelligent model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term intelligent may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented intelligent operations that approximate a human thought process while enabling a user or a computing system to interact in a more natural manner. An intelligent system may use AI logic, such as NLP based logic, for example, and machine learning logic, which may be provided as specialized hardware, software executed on hardware, or any combination of specialized hardware and software executed on hardware. The logic of the intelligent system may implement the intelligent operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and intelligent; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human intelligent based on experiences.

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

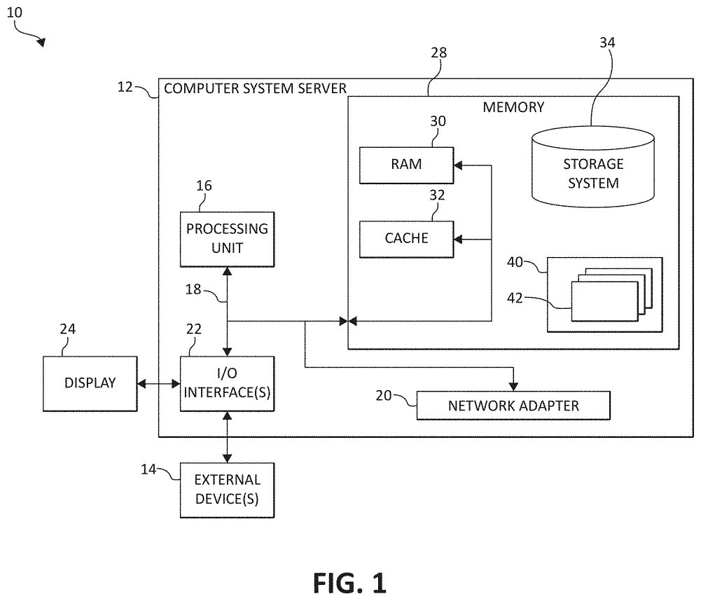

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

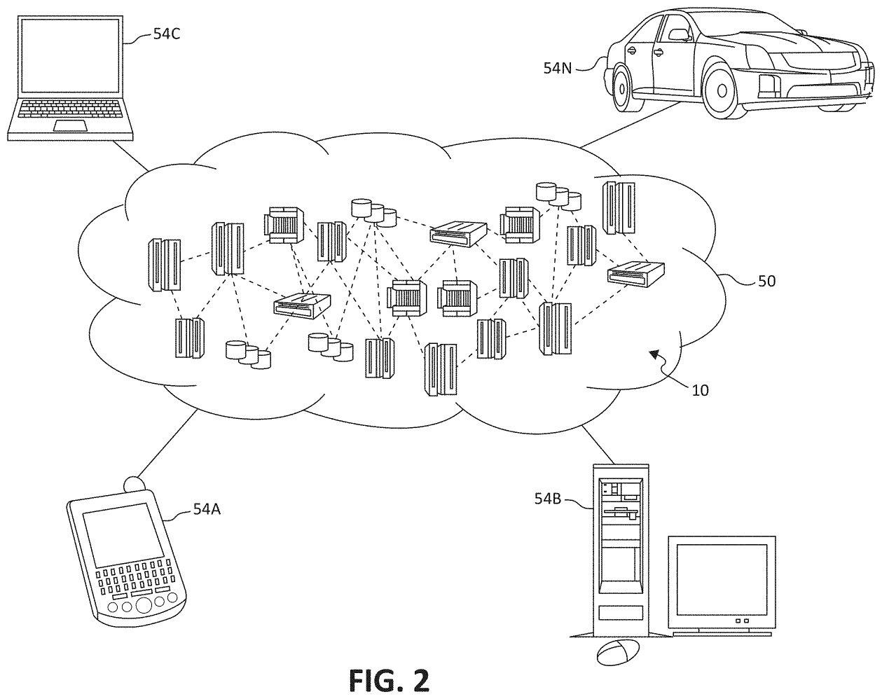

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

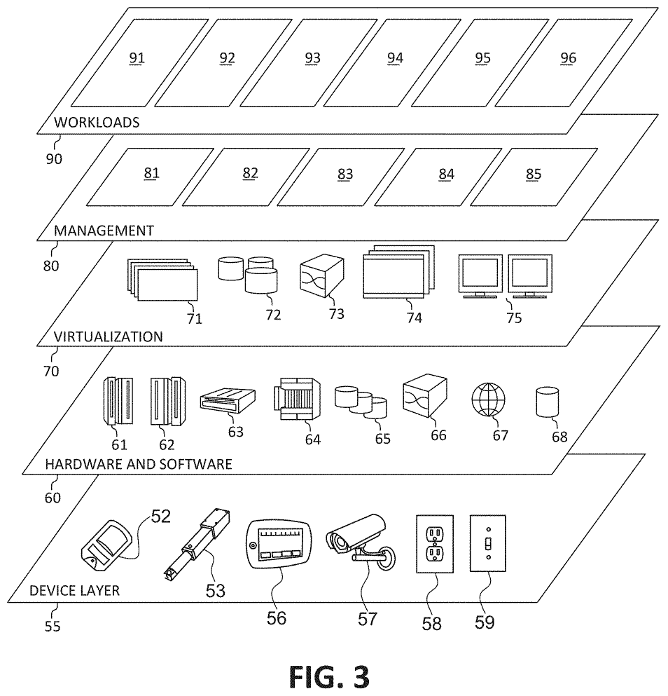

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing increased performance of various industrial systems and processes. In addition, workloads and functions 96 for providing increased performance of various industrial systems and processes may include such operations as data analytics, data analysis, and as will be further described, notification functionality. One of ordinary skill in the art will appreciate that workloads and functions 96 for providing increased performance of various industrial systems and processes may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

Thus, as described herein, in various implementation, the present disclosure provides for providing increased performance of various industrial systems and processes in a computing environment, by one or more processors, is depicted. Each of a plurality of dependencies of a plurality of entities in a knowledge graph are modeled as a graph neural network (“GNN”). A reference graph model is generated based on the modeling. One or more anomalies are monitored and detected for a plurality of process based on the reference graph model.

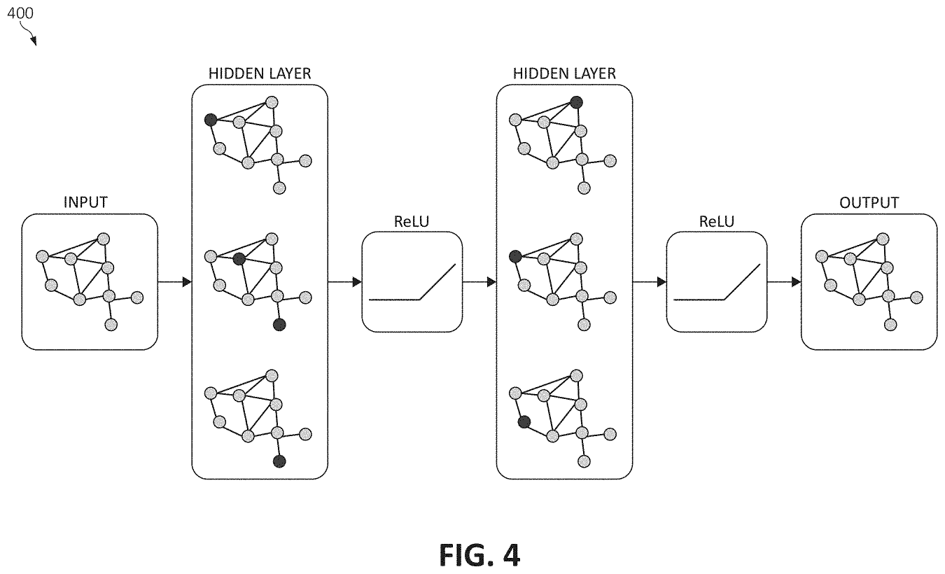

For further explanation, FIG. 4 is a diagram depicting knowledge graph and a graph neural network (e.g., a multi-layer graph convolutional networks “GCN” with first order filters) in according to an embodiment of the present invention.

As depicted, an input of a graph convolutional network is an N×D feature matrix X in which N is the number of nodes and D is the number of input features and representative description of the graph structure, typically choosing the adjacency matrix A of the graph. The output is an N×F feature matrix Z, where F is the number of output features per node. Every neural network layer could be written as a non-linear function:

H^{(l+1)}=f(H^{(l)},A) (2),

Where H^{(l)}=Xand H^{(l)}=Z, Lis the number of neural network layers. Given the definition of each neural network layer, a simple form of a layer-wise propagation rule could be written as:

f(H^{(l)},A)=σ(AH^{(l)}W^{(l)}) (3),

where W^{(l)} is a weight matrix for the lth neural network layer and σ(*) is a non-linear activation function such as, for example, an ReLU. Thus, the knowledge graph and a graph neural network (e.g., a multi-layer graph convolutional networks “GCN” with first order filters) may be used for learning various low-level abstractions until inferring weights that capture the dynamics of the state space representation of the graph 400.

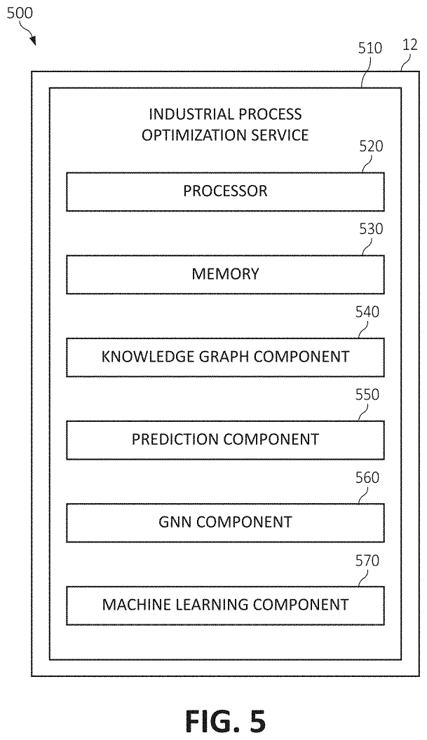

Turning now to FIG. 5, a block diagram depicting exemplary functional components of system 400 for providing increased performance of various industrial systems and processes in a computing environment according to various mechanisms of the illustrated embodiments is shown. In one aspect, one or more of the components, modules, services, applications, and/or functions described in FIGS. 1-3 may be used in FIG. 5. As will be seen, many of the functional blocks may also be considered “modules” or “components” of functionality, in the same descriptive sense as has been previously described in FIGS. 1-3.

In one aspect, the computer system/server 12 may provide virtualized computing services (i.e., virtualized computing, virtualized storage, virtualized networking, etc.) to the intelligent conversational agent management and interaction service 502 and the conversation agent 504. More specifically, the computer system/server 12 may provide virtualized computing, virtualized storage, virtualized networking and other virtualized services that are executing on a hardware substrate.

An industrial process optimization service 510 is shown, incorporating processing unit 520 (“processor”) to perform various computational, data processing and other functionality in accordance with various aspects of the present invention. In one aspect, the processor 520 and memory 530 may be internal and/or external to the industrial process optimization service 510, and internal and/or external to the computing system/server 12. The industrial process optimization service 510 may be included and/or external to the computer system/server 12, as described in FIG. 1. The processing unit 520 may be in communication with the memory 530. The industrial process optimization service 510 may include a knowledge graph component 540, a prediction component 550, an GNN component 560, and a machine learning component 570.

In one aspect, the system 500 may provide virtualized computing services (i.e., virtualized computing, virtualized storage, virtualized networking, etc.). More specifically, the system 500 may provide virtualized computing, virtualized storage, virtualized networking and other virtualized services that are executing on a hardware substrate.

The industrial process optimization service 510, in association with the knowledge graph component 540, the prediction component 450, the GNN component 560, and the machine learning component may model each of a plurality of dependencies of a plurality of entities in a knowledge graph as a graph neural network (“GNN”); generate a reference graph model based on the modeling; and monitor and detecting one or more anomalies for a plurality of process based on the reference graph model.

The industrial process optimization service 510, in association with the knowledge graph component 540, the prediction component 450, the GNN component 560, and the machine learning component may receive the knowledge graph having the plurality of entities and edges generated from training data.

The industrial process optimization service 510, in association with the knowledge graph component 540, the prediction component 450, the GNN component 560, and the machine learning component may determine one or more classifications of the one or more entities of the knowledge graph based on the modeling; and predict one or more links between the one or more entities.

The industrial process optimization service 510, in association with the knowledge graph component 540, the prediction component 450, the GNN component 560, and the machine learning component may configure one or more graph subsets identified from the knowledge graph using the GNN.

The industrial process optimization service 510, in association with the knowledge graph component 540, the prediction component 450, the GNN component 560, and the machine learning component may learn one or more features and characteristics of the knowledge graph using the GNN.

The industrial process optimization service 510, in association with the knowledge graph component 540, the prediction component 450, the GNN component 560, and the machine learning component may generate one or more vector functions for each one of the plurality of entities in the knowledge graph.

The industrial process optimization service 510, in association with the knowledge graph component 540, the prediction component 550, the GNN component 560, and the machine learning component may score each of the one or more anomalies based on the modeling indicating a degree of error between the knowledge graph and the reference graph model.

The knowledge graph embedding service 540, in association with the knowledge graph component 540, the prediction component 450, the GNN component 560, and the machine learning component may define the one or more weighted values to represent a predicted, unknown relationship between the pair of entities based on existing weighted relationships between one or more of a plurality of entities in the knowledge graph.

In some implementations, the knowledge graph component 540 may select the one or more weighted values of the edge between the pair of entities having a maximum confidence score based on the one or more candidate statements. The prediction component 550 may analyze metadata between a plurality of entities in the knowledge graph where the metadata includes numerical weights of each of the plurality of entities in the knowledge graph.

The GNN component 560, in association with the knowledge graph component 540, may incorporate numerical weights of one or more of entities in the knowledge graph into knowledge graph embeddings (“KGE”), where embedding the numerical weights of the one or more of the plurality of entities of the knowledge graph includes embedding the plurality of entities and relationships into continuous vector spaces.

The knowledge graph embedding service 510, in association with the knowledge graph component 540, the prediction component 550, the GNN component 560, and/or the machine learning component 570 may generate one or more vector functions for each one of the plurality of entities in the knowledge graph.

The knowledge graph embedding service 510, in association with the knowledge graph component 540, the prediction component 550, the GNN component 560, and/or the machine learning component 570 may generate one or more vector functions representing a relationship between each one of the plurality of entities in the knowledge graph.

In some implementations, the machine learning component 570 may learn latent embeddings of a Knowledge Graphs ontology. More specifically, the machine learning component 570 may learn when relations in a knowledge graph are given with weights and provide a model that incorporates those weights into a KGE model by preserving its numerical properties. Also, the knowledge graph embedding service 510, in association with the knowledge graph component 540, the prediction component 550, the GNN component 560, and/or the machine learning component 570 may use a link prediction procedure to predict triple weight as well as a confidence score of that weight.

The machine learning component 570 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

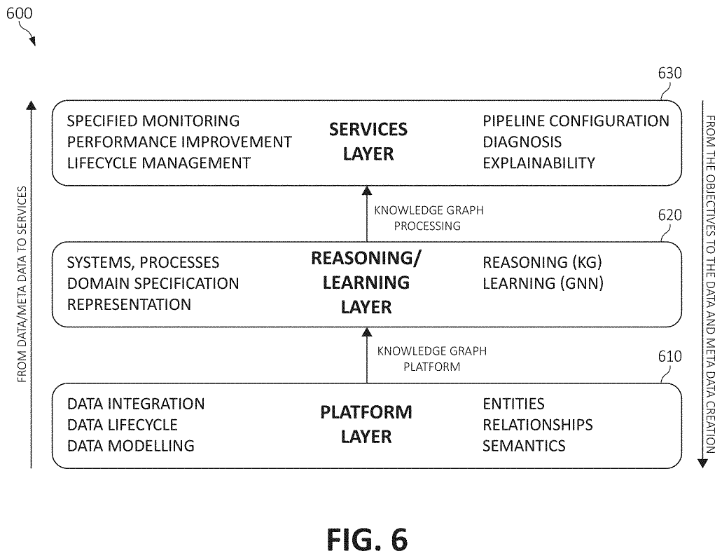

For further explanation, FIG. 6 is a block diagram 600 depicting use of providing increased performance of various industrial systems and processes. A knowledge graph platform and a graph neural network (“GNN”) in a computing environment. In one aspect, one or more of the components, modules, services, applications, and/or functions described in FIGS. 1-5 may be used in FIG. 6. Repetitive description of like elements employed in other embodiments described herein is omitted for sake of brevity.

As depicted, a platform layer 610, a reasoning/learning layer 620, and a services layer 630 may be provided for using learned physical knowledge to guide feature engineering in a computing environment.

The platform layer 610 includes processing and providing data lifecyle, data integration, and data modeling. The platform layer 610 also includes maintaining and providing the knowledge graph platform. The platform layer 610 ingests data from a database or an external sensor and processes the data towards a form amenable to machine learning. Basic data cleansing frameworks may be implemented such as outlier removal or data imputation. If meta descriptors of the data exist, these can be provided to a semantic modelling layer that extracts data context to further guide model development. Information on context can be used to guide the selection of appropriate reasoning (e.g., knowledge graph “KG”) and learning (e.g., a GNN) for the data based on given descriptors. A database of possible knowledge graphs and GNN's are also provisioned and maintained in this platform layer 610. The knowledge graphs and GNN's can be stored in a database, provided by the user, or extracted from an external database or scientific corpora using API connectors or natural language processing from pertinent sources (e.g., an external database/library or a scientific repository).

The knowledge graph platform and processing occurs between the platform layer 610 and reasoning/learning layer 620 (e.g., a machine learning layer). That is, the reasoning/learning layer 620 may use and access the knowledge graphs and GNN's.

The reasoning/learning layer 620 includes knowledge of and access to each of the computing systems, processes, domain specifications and representations. The machine learning layer 620 also includes learning the knowledge graphs and GNN's. That is, the reasoning/learning layer 620 may acting upon and relating the extracted physics equations to the input data (e.g., apply physics equations to time series data). The reasoning/learning layer 620 processes the data to 1) identify a set of possible feature transformations or combinations that could be applied to the data based on data-driven discovery of the knowledge graphs and GNN's, 2) transform the raw dataset based on the identified the knowledge graphs and GNN's, and 3) train and validate the machine learning model on the transformed features and quantify performance score. The reasoning/learning layer 620 selects the optimal combination of features and model configuration that returns the highest performance score.

The knowledge graphs and GNN's processing occurs between the reasoning/learning layer 620 and the services layer 630. That is, the most relevant the knowledge graphs and GNN's are extracted based on the data. That is, the knowledge graphs and GNN's are extracted and prioritized by the reasoning/learning layer 620 based on a match between one or more the knowledge graphs and GNN's and a given data set.

The services layer 630 may provide specified monitoring of the machine learning models, performance improvement, and lifecycle management of the machine learning models. The services layer 630 may also allow the user to interface with the trained model through configuration, diagnosis, and explainability. The services layer 630 may also provide for detecting the inconsistencies in the machine learning models. The services layer 630 may evaluate the machine learning models with the given inputs or data and identify machine learning model inconsistency and for identifying improved or decreased machine learning model performance based on the given feature engineering and transformations. Aspects related to model monitoring, management, and performance improvement are provisioned within this services layer 630. Model improvement can be provided in terms of the knowledge graphs and GNN's identified for the system. This allows the user to interpret how the raw data influences model performance and how the transformed features based on the identified the knowledge graphs and GNN's. The advantage of this approach is that it allows for a more consistent diagnosis of model results and performance compared to a naïve data transformation approach.

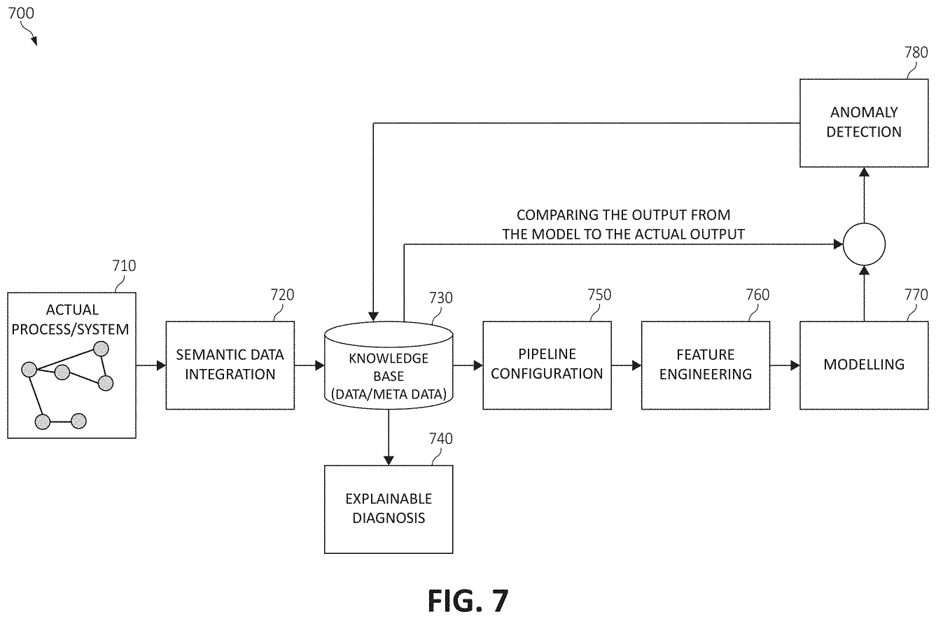

Turning now to FIG. 7, a block diagram 700 depicts exemplary operations for providing increased performance of various industrial systems and processes. In one aspect, one or more of the components, modules, services, applications, and/or functions described in FIGS. 1-6 may be used in FIG. 7. Repetitive description of like elements employed in other embodiments described herein is omitted for sake of brevity.

Starting in block 710, inputs such as, for example, one or more actual industrial system/processes 710 and semantic data integration 720 may be provided to a knowledge base 730 (e.g., a knowledge database). The inputs such as, for example, actual system/processes 710 and data integration 720 may be inputs such as, for example, features vector of a system to model, temporal and spectral features, features of a knowledge graph edges, steady state data, and features of entities in a neighborhood, etc.). Alternatively, a system could extract such information from an external database or corpora of scientific literature using data integrators or natural language processing techniques.

The knowledge base 730 may categorize the descriptors and basic functions that describe the input datasets—rather than providing this data directly to the machine learning model that transform the data into a cleaner dataset.

The pipeline configuration 750 may access and use the knowledge data and/or metadata from the knowledge base 730. The pipeline configuration 750 may using one or more automated machine learning pipelines to monitor graphs/subset of graphs and arrive at contextualized diagnosis. That is, the knowledge graph allows to have an explainable diagnosis where semantic information is integrated in the decision making process. This allows to add context to the anomaly detection, which may be referred to as “contextualized diagnosis”.

The pipeline configuration 750 may configure and monitoring machine learning pipelines for diagnosis in large scale, complex, and interconnected systems. The pipeline configuration 750 may learn the characteristics of interconnectedness between various entities of a knowledge graph to better exploit contextual information. The pipeline configuration 750 may exploit and use the similarity in a knowledge graph for improved data processing and detection/compensation of missing values and outliers, and subsequent reliable diagnosis. The pipeline configuration 750, using the physical knowledge 730, may provide an automated and simplified way to optimize the performances of complex and large-scale systems/processes by incorporating the semantic information in the knowledge representation overcomes certain of a “black box” aspects of GNN.

The feature engineering component 760 may then analyze and process the machine learning pipelines from extracted knowledge graphs and GNN's and transform the data using the feature engineering to create candidate features from the transformed that may be selected and used for training and modeling, which is used by the modeling component 770. That is, the modeling component 570 may use the candidate features created from the transformed data. By modelling the various types of complex, industrial systems, via the modeling component 570, with graphs and learning the characteristics of the graphs in terms of sensors data and meta-data, one or more anomalies may be detected, via the anomaly detection component 780, and ease the process of localization and estimation of severity of the complex, industrial systems, and consequently arrive at explainability of the complex, industrial systems.

In one aspect, the feature engineering component 760 may conduct feature engineering on the data based on known patterns in the data (e.g., for a drag force computation, one might square the velocity as drag force is proportional to the velocity) or user expertise (e.g., one might implement a log transformation to reduce the variance in the data).

In some aspects, in regard to modelling, the features generated in a feature engineering layer (outputs of the PDE transformation and any basis function representations represented) may be evaluated in terms of improved representation, which can be in terms of ranked feature importance to a machine learning model. In some implementations, this can be feeding a combination of features (e.g., raw features and transformed or generated features of the physics equations) into a machine learning model such as, for example, Random Forest and quantifying feature Importance. Those features identified as being “important” are retained for the machine learning model.

As output from the modeling component 770, one or more characteristics of the entity and the feature of the entity obtained from the knowledge base 730. Using this data, a feedback loop is executed to validate the machine learning models and also provide and detect anomalies based on the pipeline configurations, feature engineering, and machine learning models using the anomaly detection component 780. Such feedback enables model accuracy and validation, model uplift, or provides and identifies the contribution of each of the features towards machine learning model forecasting. That is, the anomaly detection component 780 may compare the output of a machine learning model to the actual output for determining the anomalies. In some aspects, the “actual output” is raw output (unprocessed) provided by a sensor information without any further processing. Whereas the output of a machine learning model is the computed output using the GNN model.

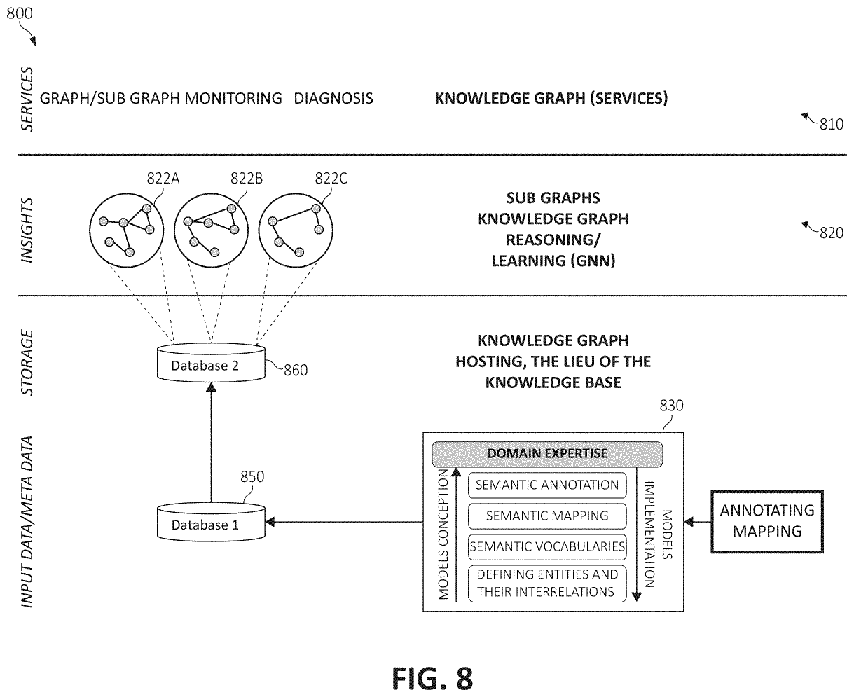

For further explanation, FIG. 8 is a block flow diagram depicting an additional exemplary operations for monitoring various industrial systems and processes (e.g., in a computing environment according to an embodiment of the present invention (e.g., a monitoring the various industrial systems and processes by using, for example, a database that stores a knowledge graph where the basis of the knowledge about the modeled industrial system can be found). As shown, the various functionality, or “modules” of functionality, hardware devices, and/or other components in the same descriptive sense as has been previously described in FIGS. 1-7 may be included in FIG. 8. In one aspect, one or more of the components, modules, services, applications, and/or functions described in FIGS. 1-7 may be used in FIG. 8. Repetitive description of like elements employed in other embodiments described herein is omitted for sake of brevity.

By way of example only, the monitoring operations include an input data/meta layer, a storage layer, insights layer, and a services layer.

Starting in block 830, an annotating mapping operation may be executed from data and metadata that includes semantic annotations, semantic mappings, semantic vocabularies, and definitions of entities and interrelations of a knowledge graph, which may be input, learned, received, or labeled via a domain expert for machine learning model implementation and conception.

In blocks 850 and 860, first database 850 (“database 1” e.g., a cross-platform document-oriented database) and a second database 860 (e.g., database 2″ may be used to store and process the knowledge graphs received from block 830.

Blocks 822A-C are sub-graphs of the knowledge graph created, identified, and/or generated from the knowledge graphs of blocks 850 and 860. A reasoning and learning (e.g., knowledge graph and GNN) operations are used on the sub-graphs 822A0C where the sub-graphs 822A0C are a subset of the knowledge graph and are used to determine more accurate and explainable diagnosis and improved interpretable results.

As such, a knowledge graph/sub-graph monitoring and diagnosis operations (e.g., “knowledge graph services”) may be executed for automated monitoring of large scale and complex industrial processes.

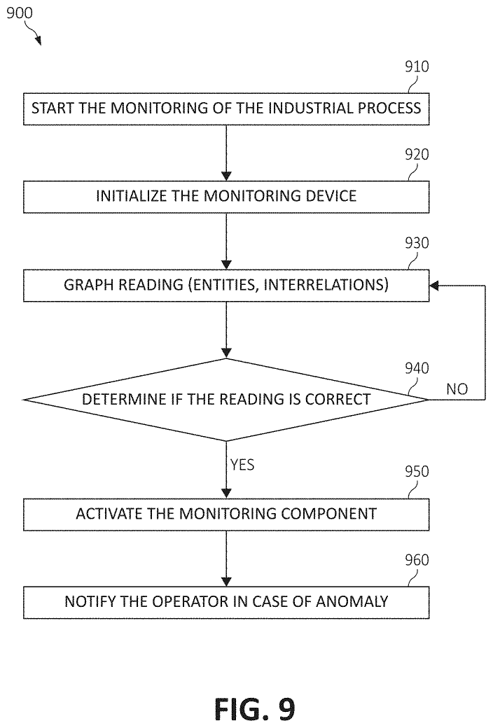

Turning now to FIG. 9, a method 900 for monitoring industrial systems and processes by a processor is depicted, in which various aspects of the illustrated embodiments may be implemented. The functionality 900 may be implemented as a method executed as instructions on a machine, where the instructions are included on at least one computer readable medium or one non-transitory machine-readable storage medium. As one of ordinary skill in the art will appreciate, the various steps depicted in method 900 may be completed in an order or version differing from the depicted embodiment to suit a particular scenario.

The functionality 900 may start in block 910 by starting a monitoring of one or more industrial processes. A monitoring device may be initialized, as in block 920. One or more graph readings (e.g., entities and interrelations between the entities) may be read (e.g., identified and analyzed), as block 930. Aa determination operation may be performed to determine if the reading of the graph is correct, as in block 940. If no, the method 900 may move back to block 930. If yes, the monitoring comment may be activated, as in block 950. A notification may be issued in the event an anomaly is detected, as in block 960 (e.g., an operator of one or more industrial systems or process may be notified).

Thus, the operations of method 900 of FIG. 9 may be used for knowledge graph reading, graph correctness and validation, activation of a monitoring component, and notify operators of anomalies.

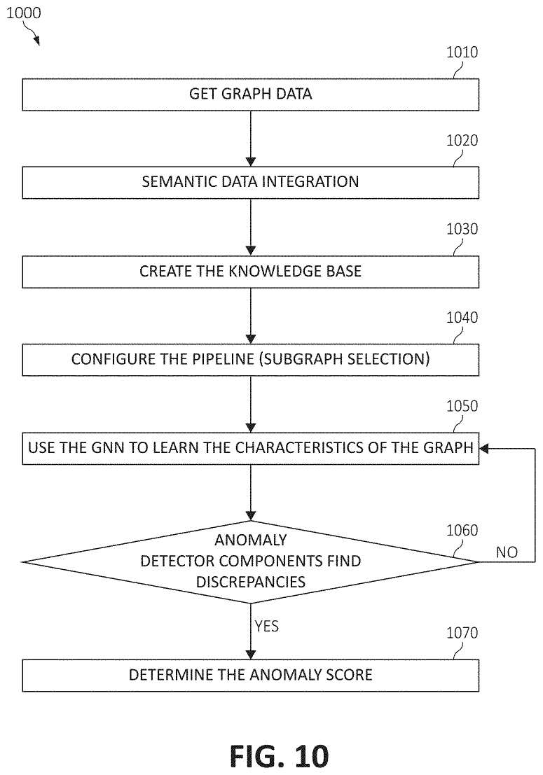

Turning now to FIG. 10, a method 1000 for monitoring industrial systems and processes by a processor is depicted, in which various aspects of the illustrated embodiments may be implemented. The functionality 1000 may be implemented as a method executed as instructions on a machine, where the instructions are included on at least one computer readable medium or one non-transitory machine-readable storage medium. As one of ordinary skill in the art will appreciate, the various steps depicted in method 1000 may be completed in an order or version differing from the depicted embodiment to suit a particular scenario.

The functionality 1000 may start in block 1010 by obtaining knowledge graph data. The graph data may be used to learn the structure of a graph (entities, interrelations) using, for example, convolutional Neural Network and/or long strong term memory networks (“LSTM”) can be used (e.g., a GNN). Semantic data may be integrated with the graph data, as in block 1020.

A knowledge base may be created, as in block 1030. One or more pipelines (e.g., subgraph selection that may be performed to focus the monitoring on a specific section of the knowledge graph) may be configured, as in block 1040. A GNN may be used to learn characteristics of the graph, as in block 1050. An operation may be used to determine if there are anomalies in the graphs or sub-graphs, as in block 1060 (e.g., via an anomaly detector component). If no, the method may move back to block 1040. If yes, the method moves to block 1080, where an anomaly score may be detected.

Thus, by learning to extract features and to reconstruct a graph network or its subset, a knowledge graph model may be provided to reconstruct graphs or subgraphs similar to those observed in a training set. The graphs or sub-graphs which show significant discrepancies from those observed during training will lead to errors. The discrepancies in the graph reconstruction are subsequently used as an anomaly score.

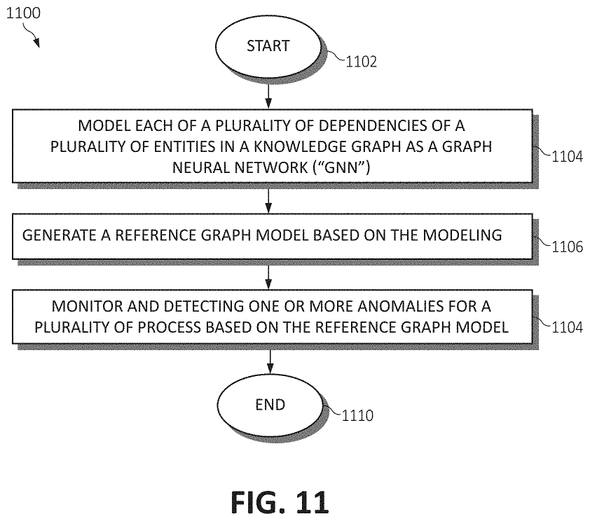

Turning now to FIG. 11, a method 1100 for providing increased performance of various industrial systems and processes by a processor is depicted, in which various aspects of the illustrated embodiments may be implemented. The functionality 1100 may be implemented as a method executed as instructions on a machine, where the instructions are included on at least one computer readable medium or one non-transitory machine-readable storage medium. As one of ordinary skill in the art will appreciate, the various steps depicted in method 800 may be completed in an order or version differing from the depicted embodiment to suit a particular scenario. The functionality 1100 may start in block 1102.

Each of a plurality of dependencies of a plurality of entities in a knowledge graph are modeled as a graph neural network (“GNN”), as in block 1104. A reference graph model is generated based on the modeling, as in block 1106. One or more anomalies are monitored and detected for a plurality of process based on the reference graph model, as in block 1108. The functionality 1100 may end in block 1110.

In one aspect, in conjunction with and/or as part of at least one block of FIG. 11, the operations of method 1100 may include each of the following. The operations of method 1100 may receive the knowledge graph having the plurality of entities and edges generated from training data. The operations of method 1100 may determine one or more classifications of the one or more entities of the knowledge graph based on the modeling; and predict one or more links between the one or more entities.

The operations of method 1100 may generate one or more vector functions for each one of the plurality of entities in the knowledge graph. The operations of method 800 may generate one or more vector functions representing a relationship between each one of the plurality of entities in the knowledge graph.

The operations of method 1100 may configure one or more graph subsets identified from the knowledge graph using the GNN. The operations of method 1100 may learn one or more features and characteristics of the knowledge graph using the GNN. The operations of method 1100 may generate one or more vector functions for each one of the plurality of entities in the knowledge graph. The operations of method 1100 may score each of the one or more anomalies based on the modeling indicating a degree of error between the knowledge graph and the reference graph model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for providing increased performance processes in a computing environment by a processor, comprising:
modeling each of a plurality of dependencies of a plurality of entities in a knowledge graph as a graph neural network (“GNN”);
generating a reference graph model based on the modeling; and
monitoring and detecting one or more anomalies for a plurality of process based on the reference graph model.

2. The method of claim 1, further including receiving the knowledge graph having the plurality of entities and edges generated from training data.

3. The method of claim 1, further including
determining one or more classifications of the one or more entities of the knowledge graph based on the modeling; and
predicting one or more links between the one or more entities.

4. The method of claim 1, further including configuring one or more graph subsets identified from the knowledge graph using the GNN.

5. The method of claim 1, further including learning one or more features and characteristics of the knowledge graph using the GNN.

6. The method of claim 1, further including generating one or more vector functions for each one of the plurality of entities in the knowledge graph.

7. The method of claim 1, further including scoring each of the one or more anomalies based on the modeling indicating a degree of error between the knowledge graph and the reference graph model.

8. A system for providing increased performance of various industrial systems and processes in a computing system in a computing environment, comprising:
one or more computers with executable instructions that when executed cause the system to:
model each of a plurality of dependencies of a plurality of entities in a knowledge graph as a graph neural network (“GNN”);
generate a reference graph model based on the modeling; and
monitor and detecting one or more anomalies for a plurality of process based on the reference graph model.

9. The system of claim 8, wherein the executable instructions when executed cause the system to receive the knowledge graph having the plurality of entities and edges generated from training data.

10. The system of claim 8, wherein the executable instructions when executed cause the system to:
determine one or more classifications of the one or more entities of the knowledge graph based on the modeling; and
predict one or more links between the one or more entities.

11. The system of claim 8, wherein the executable instructions when executed cause the system to configure one or more graph subsets identified from the knowledge graph using the GNN.

12. The system of claim 8, wherein the executable instructions when executed cause the system to learn one or more features and characteristics of the knowledge graph using the GNN.

13. The system of claim 8, wherein the executable instructions when executed cause the system to generate one or more vector functions for each one of the plurality of entities in the knowledge graph.

14. The system of claim 8, wherein the executable instructions when executed cause the system to score each of the one or more anomalies based on the modeling indicating a degree of error between the knowledge graph and the reference graph model.

15. A computer program product for providing increased performance of various industrial systems and processes in a computing environment, the computer program product comprising:
one or more computer readable storage media, and program instructions collectively stored on the one or more computer readable storage media, the program instruction comprising:
program instructions to model each of a plurality of dependencies of a plurality of entities in a knowledge graph as a graph neural network (“GNN”);
program instructions to generate a reference graph model based on the modeling; and
program instructions to monitor and detecting one or more anomalies for a plurality of process based on the reference graph model.

16. The computer program product of claim 15, further including program instructions to:
receive the knowledge graph having the plurality of entities and edges generated from training data;
determine one or more classifications of the one or more entities of the knowledge graph based on the modeling; and
predict one or more links between the one or more entities.

17. The computer program product of claim 15, further including program instructions to configure one or more graph subsets identified from the knowledge graph using the GNN.

18. The computer program product of claim 15, further including program instructions to learn one or more features and characteristics of the knowledge graph using the GNN.

19. The computer program product of claim 15, further including program instructions to generate one or more vector functions for each one of the plurality of entities in the knowledge graph.

20. The computer program product of claim 15, further including program instructions to score each of the one or more anomalies based on the modeling indicating a degree of error between the knowledge graph and the reference graph model.
